(19) United States
(12) Patent Application Publication
(10) Pub. No.: US 2026/0299873 A1
(43) Pub. Date: Oct. 1, 2026

(54) ELECTRONIC DEVICE AND METHOD FOR PERFORMING AUDIO COMMUNICATION BETWEEN FIRST SPACE AND SECOND SPACE

(71) Applicant: Realtek Semiconductor Corp., HsinChu (TW)

(72) Inventors: Chung-Shih Chu, HsinChu (TW); Chieh-Min Tsai, HsinChu (TW); Tien-chiu Hung, HsinChu (TW); Wei-Chung Ting, HsinChu (TW)

(73) Assignee: Realtek Semiconductor Corp., HsinChu (TW)

(21) Appl. No.: 19/634,019

(22) Filed: Mar. 30, 2026

(30) Foreign Application Priority Data
Mar. 31, 2025 (TW) 114112328

(51) Int. Cl. G06F 3/16; H04R 3/00; H04R 3/04; H04R 3/12; H04R 29/00

(52) U.S. Cl. CPC G06F 3/162; H04R 3/005; H04R 3/04; H04R 3/12; H04R 29/002

(57) ABSTRACT

An electronic device and a method for performing audio communication between a first space and a second space are provided, where the electronic device is one of multiple near-end devices in the first space. When the electronic device is taken as a master device, each of the other near-end devices is taken as a slave device. A network receiver of the master device obtains an original far-end audio signal from a far-end device in the second space through an internet connection, and an audio processing circuit of the master device processes the original far-end audio signal to generate a master audio signal and a slave audio signal, where a speaker of the master device plays a master output audio signal according to the master audio signal, and a speaker of the slave device plays a slave output audio signal according to the slave audio signal from the master device.

### BACKGROUND OF THE INVENTION

### 1. Field of the Invention

The present invention is related to audio conferences or multi-person voice calls, and more particularly, to an electronic device and a method for performing audio communication between a first space and a second space.

### 2. Description of the Prior Art

When making a conference call, attendees located in a same conference room may use their respective laptop computers to capture and play audio signals, instead of using a shared conference-call speaker. Each laptop computer may have a different delay due to factors such as internet speed, system processing latency, sound effect design, etc., where these delay differences may be up to several seconds. When the delay difference is too large, although multiple laptop computers play the same audio, the delay differences may cause listeners to perceive the sound as echoes or reverberations, degrading the clarity of the voice messages. In addition, when multiple laptop computers in the conference room play sound and capture voice signals simultaneously, a loop formed by the playback/recording of the audio causes a howling feedback problem.

Thus, there is a need for a novel mechanism and an associated method to improve the playback/recording quality and overall user experience of multiple laptop computers making a conference call in the same space without introducing any side effect or in a way that is less likely to introduce side effects.

### SUMMARY OF THE INVENTION

An objective of the present invention is to provide an electronic device and a method for performing audio communication between a first space and a second space, which can improve an overall playback effect of multiple near-end devices playing the same audio signal in the same space.

At least one embodiment of the present invention provides an electronic device for performing audio communication between a first space and a second space. Multiple near-end devices are located in the first space, and at least one far-end device is located in the second space, where the electronic device is one of the multiple near-end devices. The electronic device comprises a network receiver, an audio processing circuit, and a speaker, where the speaker is coupled to the audio processing circuit. The network receiver is configured to obtain an original far-end audio signal from the at least one far-end device via internet, the audio processing circuit is configured to generate a processed audio signal according to a detection result corresponding to the original far-end audio signal, and the speaker is configured to play an output audio signal according to the processed audio signal. When the electronic device is selected to be a master device, each of the other near-end devices is selected to be a slave device, the audio processing circuit of the master device processes the original far-end audio signal according to the detection result to generate a master audio signal and slave audio signals, the master device transmits the slave audio signal to the slave device via a transmission interface, to make the speaker of the slave device play a slave output audio signal according to the slave audio signal, and the speaker of the master device plays a master output audio signal according to the master audio signal.

At least one embodiment of the present invention provides a method for performing audio communication between a first space and a second space, where multiple near-end devices are located in the first space, and at least one far-end device is located in the second space. The method comprises: selecting one of the multiple near-end devices to be a master device and setting each of the other near-end devices to be a slave device, wherein each of the multiple near-end devices comprises a network receiver, an audio processing circuit and a speaker; utilizing the network receiver of the master device to obtain an original far-end audio signal from the at least one far-end device via internet; utilizing the audio processing circuit of the master device to process the original far-end audio signal according to a detection result corresponding to the original far-end audio signal to generate a master audio signal and a slave audio signal; utilizing the master device to transmit the slave audio signal to the slave device via a transmission interface, to make the speaker of the slave device play a slave output audio signal according to the slave audio signal; and utilizing the speaker of the master device to play a master output audio signal according to the master audio signal.

The electronic device and the method provided by the embodiments of the present invention can utilize the master device to process an audio signal to be played (e.g. an audio signal from the far-end device) and allocate it to other near-end devices, and more particularly, can accordingly process the audio signal according to configuration of a speaker array formed by the other near-end devices, thereby improving the sound playback effect of the space where these near-end devices located in. In addition, the present invention will not greatly increase additional costs. Thus, the present invention can solve the problem of the related art without introducing any side effect or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating multiple near-end devices in a first space performing audio communication with at least one far-end device in a second space according to an embodiment of the present invention.

FIG. 2A is a diagram illustrating multiple near-end devices communicating with one another via a peer-to-peer protocol or ultrasound reception/transmission according to an embodiment of the present invention.

FIG. 2B is a diagram illustrating communication interface circuits of multiple near-end devices communicating with one another via ultrasound reception/transmission according to an embodiment of the present invention.

FIG. 3 is a diagram illustrating a working flow of a method for performing audio communication between a first space and a second space according to an embodiment of the present invention.

FIG. 4 is a diagram illustrating a display screen of multiple users having a conference call according to an embodiment of the present invention.

FIG. 5 is a diagram illustrating calibration of frequency responses of the sounds received by multiple near-end devices according to an embodiment of the present invention.

FIG. 6 is a diagram illustrating a directional speaker implemented by multiple near-end devices according to an embodiment of the present invention.

### DETAILED DESCRIPTION

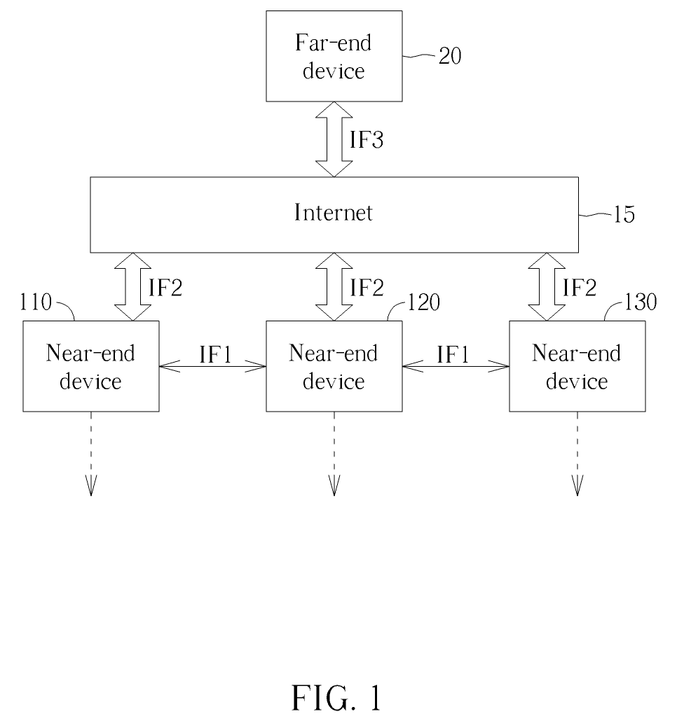

FIG. 1 is a diagram illustrating multiple near-end devices (e.g. near-end devices 110, 120 and 130) in a first space performing audio communication with at least one far-end device (e.g. a far-end device 20) in a second space according to an embodiment of the present invention, where the near-end devices 110, 120 and 130 may communicate with each other via a transmission interface IF1, each of the near-end devices 110, 120 and 130 may communicate with an internet connection (e.g. the internet 15) via a transmission interface IF2, and the far-end device 20 may communicate with the internet 15 via a transmission interface IF3. For example, the near-end devices 110, 120 and 130 may make a conference call with the far-end device 20 via the internet 15, where the near-end devices 110, 120 and 130 may be multiple laptop computers located in the same conference room, and the far-end device 20 may be a laptop computer located in another space. In another example, the near-end devices 110, 120 and 130 may play an online game with the far-end device 20 via the internet 15, where the near-end devices 110, 120 and 130 may be multiple game consoles located in the same space, and the far-end device 20 may be a game console located in another space. In this embodiment, when the far-end device 20 receives a sound signal in the second space, the far-end device 20 may transmit an original far-end audio signal corresponding to this sound signal to the internet 15 via the transmission interface IF3, where each of the near-end devices 110, 120 and 130 may obtain the original far-end audio signal output by the far-end device 20 from the internet 15 via the transmission interface IF2. When the near-end device 120 is selected to be a master device as also called a group owner (GO) device, each of the other near-end devices such as 110 and 130 may be selected to be a slave device, where the master device (e.g. the near-end device 120) may process the original far-end audio signal to generate a master audio signal and multiple slave audio signals. More particularly, the master device (e.g. the near-end device 120) may transmit a first slave audio signal among the multiple slave audio signals to the slave device (e.g. the near-end device 110), and transmit a second slave audio signal among the multiple slave audio signals to the slave device (e.g. the near-end device 130), where the slave device may discard the original far-end audio signal obtained from the internet 15 via the transmission interface IF2 (e.g. the near-end device 110 may discard the original far-end audio signal obtained by the near-end device 110 from the internet 15 via the transmission interface IF2, and the near-end device 130 may discard the original far-end audio signal obtained by the near-end device 130 from the internet 15 via the transmission interface IF2). Under this configuration, the near-end device 120 may perform playback according to the master audio signal, the near-end device 110 may perform playback according to the first slave audio signal, and the near-end device 130 may perform playback according to the second slave audio signal.

In some embodiments, when the near-end device 120 is the first near-end device connected to the audio communication between the first space and the second space among the multiple near-end devices (e.g. the near-end devices 110, 120 and 130), the near-end device 120 may be selected to be the master device. For example, when the near-end device 120 shown in FIG. 1 is the first device connected to an online conference call among the near-end devices 110, 120 and 130 (which means that the near-end devices 110 and 130 have not yet been connected to the online conference call at this moment), the near-end device 120 may start to broadcast ultrasound messages (e.g. messages containing conference-related information such as a conference identification code). At this moment, the near-end device 120 does not receive ultrasound messages (e.g. ultrasound messages responding to the broadcast of the near-end device 120) transmitted from other near-end devices, so the near-end device 120 may be set to be the master device. When the other near-end devices such as 110 and 130 are connected to the online conference call after the near-end device 120 (or when they enter the first space after the near-end device 120), the near-end devices 110 and 130 may transmit ultrasound signals (e.g. messages containing conference-related information such as the conference identification code) respectively. Since the near-end device 120 has been set to be the master device, the near-end device 120 may reply with corresponding ultrasound reply messages in response to the ultrasound signals transmitted by the near-end devices 110 and 130 respectively, and the near-end devices 110 and 130 may receive the ultrasound messages from the master device (e.g. the near-end device 120) and be set to be the slave device accordingly. Through the ultrasound broadcast and communication mentioned above, the near-end device 120 may accordingly determine whether other near-end devices exist in the same space (e.g. the first space), and may also utilize the ultrasound to detect distances and angles between the devices to establish a topology of the microphone array and the speaker array. In another example, when the near-end device 120 enters the first space and attempts to receive an ultrasound signal, if the near-end device 120 does not successfully receive an ultrasound signal from other near-end devices, the near-end device 120 may be automatically set to be the master device, and then start to periodically transmit ultrasound signals. Thus, when the near-end devices 110 and 130 enter the first space and attempt to receive ultrasound signals, the near-end devices 110 and 130 may receive the ultrasound signal from the near-end device 120, and the near-end devices 110 and 130 may be automatically set to be the slave device accordingly.

In some embodiments, after the near-end devices 110, 120 and 130 are all connected to the online conference call, each near-end device among the near-end devices 110, 120 and 130 may test stability of connection to the internet 15 of the each near-end device, where when a specific near-end device (e.g. the near-end device 120) is a near-end device having best network stability among the near-end devices 110, 120 and 130, the specific near-end device (e.g. the near-end device 120) may be selected to be the master device, and the other near-end devices (e.g. 110 and 130) may be set to be the slave device.

In some embodiments, after the near-end devices 110, 120 and 130 are all connected to the online conference call, each near-end device among the near-end devices 110, 120 and 130 may select a device (e.g. the near-end device 120) located at an optimized position to be the master device according to the topology of the speaker array and the microphone array, and the other near-end devices (e.g. 110 and 130) may be set to be the slave device.

In some embodiments, the near-end device serving as the master device may be dynamically switched. Assume that the near-end device 120 is set to be the master device and the other near-end devices such as 110 and 130 are set to be the slave device at the beginning, where the near-end device 120 serving as the master device may generate a master received signal according to a sound signal received by the near-end device 120 (e.g. a microphone therein) from a sound source in the first space, and each near-end device of the near-end devices 110 and 130 serving as the slave device may generate a slave received signal according to a sound signal received by the each near-end device (e.g. a microphone therein) from the sound source. The master device (e.g. the near-end device 120) may obtain the slave received signal from the slave device (e.g. each of the near-end devices 110 and 130) via the transmission interface IF1. When the near-end device 120 (e.g. an audio processing circuit or a controller therein) determines that a difference between a slave audio indicator (e.g. an intensity or sound quality of the sound signal received by the microphone of the near-end device 110) of the slave received signal generated by a specific near-end device (e.g. the near-end device 110) among the near-end devices 110 and 130 and a master audio indicator of the master received signal generated by the near-end device 120 (e.g. an intensity or sound quality of the sound signal received by the microphone of the near-end device 120) reaches a predetermined threshold (e.g. the intensity of the sound signal received by the microphone of the near-end device 110 is greater than the intensity of the sound signal received by the microphone of the near-end device 120 and a difference between them is greater than the predetermined threshold), the near-end device 120 may be switched to be the slave device, and the near-end device 120 may notify the specific near-end device (e.g. the near-end device 110) that it can be switched to be the master device via the transmission interface IF1. After completing the switching, the above operations executed by the master device (e.g. generating the slave audio signal and transmitting the slave audio signal to the other near-end devices) are executed by the near-end device 110 instead. It should be noted that if the near-end device 110 is directly switched to be the master device when someone is still speaking in the first space while the near-end device 120 serves as the master device, the speaker of the near-end device 110 will play the voice signal spoken in the first space before the switching as a far-end voice signal due to a network delay right after switching to the master device. Thus, when the near-end device 120 is to release the position of the master device, it needs to wait for a delay time interval after releasing, and then notify the near-end device 110 to take over the position of the master device. In some embodiments, in order to avoid the voice signal in the first space from being interrupted due to the switching of the master device, the master device may determine whether the current moment is a suitable switching time point according to whether the intensity of the voice signal in the first space is low enough.

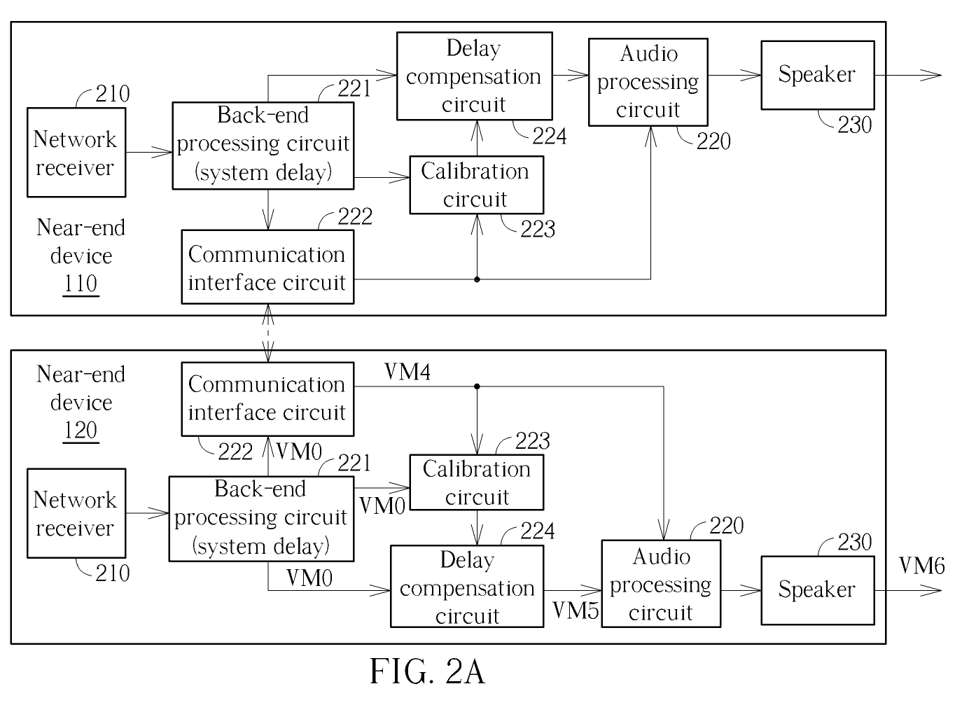

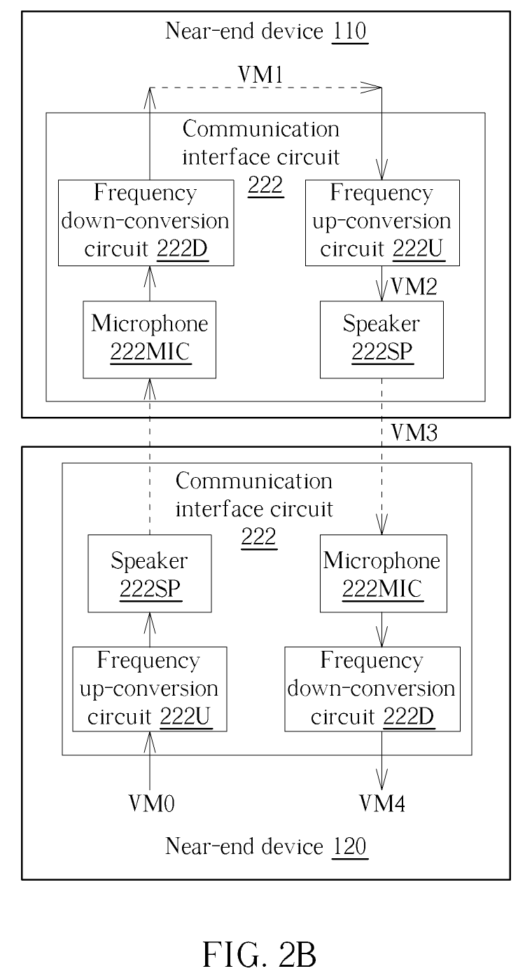

FIG. 2A is a diagram illustrating multiple near-end devices such as 110 and 120 communicating with one another via a peer-to-peer protocol (e.g. Wi-Fi direct transmission) or ultrasound reception/transmission according to an embodiment of the present invention. For convenience of explanation, assume that the near-end device 120 is selected to be the master device and the near-end device 110 is selected to be the slave device, where the far-end device 20 and the internet 15 are not illustrated in FIG. 2A for brevity. In this embodiment, each of the near-end devices 110 and 120 may comprise a network receiver 210, a back-end processing circuit 221, a communication interface circuit 222, a calibration circuit 223, a delay compensation circuit 224, an audio processing circuit 220 and a speaker 230 (e.g. loudspeaker), where the back-end processing circuit 221 is coupled to the network receiver 210, the communication interface circuit 222 is coupled to the back-end processing circuit 221, the calibration circuit 223 is coupled to the back-end processing circuit 221 and the communication interface circuit 222, the delay compensation circuit 224 is coupled to the back-end processing circuit 221 and the calibration circuit 223, the audio processing circuit 220 is coupled to the communication interface circuit 222 and the delay compensation circuit 224, and the speaker 230 is coupled to the audio processing circuit 220. In this embodiment, the network receiver 210 is configured to obtain the original far-end audio signal from the far-end device 20 via the internet 15, and the back-end processing circuit 221 may perform back-end processing on the original far-end audio signal (which may cause a system latency), where the original far-end audio signal obtained by the network receiver 210 of the near-end device 110 serving as the slave device may be discarded. In addition, the audio processing circuit 220 is configured to generate a processed audio signal according to a detection result corresponding to the original far-end audio signal, and the speaker 230 is configured to play an output audio signal according to the processed audio signal. Specifically, when the near-end device 120 is selected to be the master device, each of the other near-end devices (e.g. the near-end device 110) may be selected to be the slave device, where the audio processing circuit 220 of the near-end device 120 may process the original far-end audio signal (e.g. an audio signal VM0 received by the network receiver 210 of the near-end device 120) according to the detection result to generate a master audio signal and a slave audio signal. In this embodiment, the near-end device 120 may transmit the slave audio signal (e.g. the audio signal VM0 transmitted by the back-end processing circuit 221 to the communication interface circuit 222) to the near-end device 110 (e.g. the communication interface circuit 222 therein) via the communication interface circuit 222 therein, to make the speaker 230 of the near-end device 110 play a slave output audio signal according to the slave audio signal, and the speaker 230 of the near-end device 120 play a master output audio signal (e.g. provided for the speaker 230 to play after being processed by the delay compensation circuit 224 and the audio processing circuit 220) according to the master audio signal (e.g. the audio signal VM0 transmitted by the back-end processing circuit to the delay compensation circuit 224).

In this embodiment, the communication between the communication interface circuit 222 of the near-end device 120 and the communication interface circuit 222 of the near-end device 110 may be an example of the transmission interface IF1, where the communication interface circuit 222 of the near-end device 120 and the communication interface circuit 222 of the near-end device 110 may be a Wi-Fi peer-to-peer (P2P) transmission interface such as a Wi-Fi direct transmission interface, and the master device (e.g. the near-end device 120) may perform Wi-Fi P2P transmission with the slave device (e.g. the near-end device 110) via the Wi-Fi direct transmission interface, to transmit the slave audio signal such as an audio signal VM1 to the slave device (e.g. the near-end device 110). In some embodiments, the master device (e.g. the near-end device 120) may modulate the slave audio signal on an ultrasound signal to make the speaker of the master device play the ultrasound signal, and a microphone of the slave device (e.g. the near-end device 110) receives the ultrasound signal played by the speaker of the master device, to allow the slave device (e.g. the near-end device 110) to obtain the slave audio signal modulated on the ultrasound signal. That is, the transmission/reception of ultrasound may be another example of the transmission interface IF1.

In this embodiment, the detection result corresponding to the original far-end audio signal mentioned above may comprise a delay of the master device (e.g. the near-end device 120) transmitting the slave audio signal to the slave device (e.g. the near-end device 110) via the transmission interface IF1 (e.g. a delay of the slave output audio signal relative to the master output audio signal). In some embodiments, the master device (e.g. the near-end device 120) may obtain timestamp information corresponding to the slave output audio signal from the near-end device 110 via the communication interface circuit 222 therein, and the audio processing circuit 220 of the near-end device 120 may control a delay of the master output audio signal according to the timestamp information (e.g. the calibration circuit 223 of the near-end device 120 may compare the timestamp information corresponding to the slave output audio signal and timestamp information corresponding to the master output audio signal, to allow the delay compensation circuit 224 of the near-end device 120 to output a compensation result to the audio processing circuit 220 of the near-end device 120 according to a comparison result of the calibration circuit 223 of the near-end device 120), to reduce or eliminate the delay of the slave output audio signal relative to the master output audio signal.

FIG. 2B is a diagram illustrating multiple near-end devices such as 110 and 120 communicating with one another via ultrasound reception/transmission according to an embodiment of the present invention, where each of the respective communication interface circuits 222 of the near-end device 110 and the near-end device 120 may comprise an frequency up-conversion circuit 222U, a speaker 222SP, a microphone 222MIC and a frequency down-conversion circuit 222D. In some embodiments, the speaker 230 of the near-end device 110 shown in FIG. 2A and the speaker 222SP of the communication interface circuit 222 of the near-end device 110 shown in FIG. 2B may be the same speaker, and the speaker 230 of the near-end device 120 shown in FIG. 2A and the speaker 222SP of the communication interface circuit 222 of the near-end device 120 shown in FIG. 2B may be the same speaker. In some embodiments, the speaker 230 of the near-end device 110 shown in FIG. 2A and the speaker 222SP of the communication interface circuit 222 of the near-end device 110 shown in FIG. 2B may be different speakers, and the speaker 230 of the near-end device 120 shown in FIG. 2A and the speaker 222SP of the communication interface circuit 222 of the near-end device 120 shown in FIG. 2B may be different speakers. In addition, the near-end devices 110 and 120 may utilize the ultrasound transmission/reception to estimate the delay of the slave output audio signal relative to the master output audio signal, and perform delay compensation accordingly. For example, after the slave device (e.g. the near-end device 110) obtains the slave audio signal (e.g. a slave audio signal generated by the frequency down-conversion circuit 222D of the near-end device 110 frequency down-converting the ultrasound signal received by the microphone 222MIC of the near-end device 110 from the speaker 222SP of the near-end device 120) such as an audio signal VM1 from the master device (e.g. the near-end device 120) via the communication interface circuit 222 therein, the near-end device 110 may generate an ultrasound signal VM2 according to the audio signal VM1 (e.g. the frequency up-conversion circuit 222U of the audio processing circuit of the near-end device 110 frequency up-converts a part of the audio signal VM1 to an ultrasound frequency band to generate the ultrasound signal VM2), to make the slave output audio signal such as an audio signal VM3 played by the speaker 222SP of the near-end device 110 comprise the slave audio signal (e.g. the audio signal VM1) and the ultrasound signal VM2. After the microphone 222MIC of the master device (e.g. the near-end device 120) receives the slave output audio signal such as the audio signal VM3, the frequency down-conversion circuit 222D of the communication interface circuit 222 of the near-end device 120 may frequency down-convert the ultrasound signal VM2 of the audio signal VM3 to generate an audio signal VM4, and the calibration circuit 223 of the near-end device 120 shown in FIG. 2A may estimate the delay of the slave output audio signal relative to the master output audio signal according to the audio signal VM4 (e.g. estimating by comparing the audio signal VM4 and the audio signal VM0). In addition, the delay compensation circuit 224 may apply a corresponding delay amount to the master audio signal (or the original far-end audio signal such as VM0) according to an estimation result of the delay, to generate a master delayed audio signal (e.g. an audio signal VM5) provided for the speaker 230 to play the master output audio signal such as an audio signal VM6 according to the master delayed audio signal (e.g. the audio processing circuit 220 transmits a processing result to the speaker 230 for playback after performing front-end processing on the audio signal VM5), to reduce or eliminate the delay of the slave output audio signal relative to the master output audio signal.

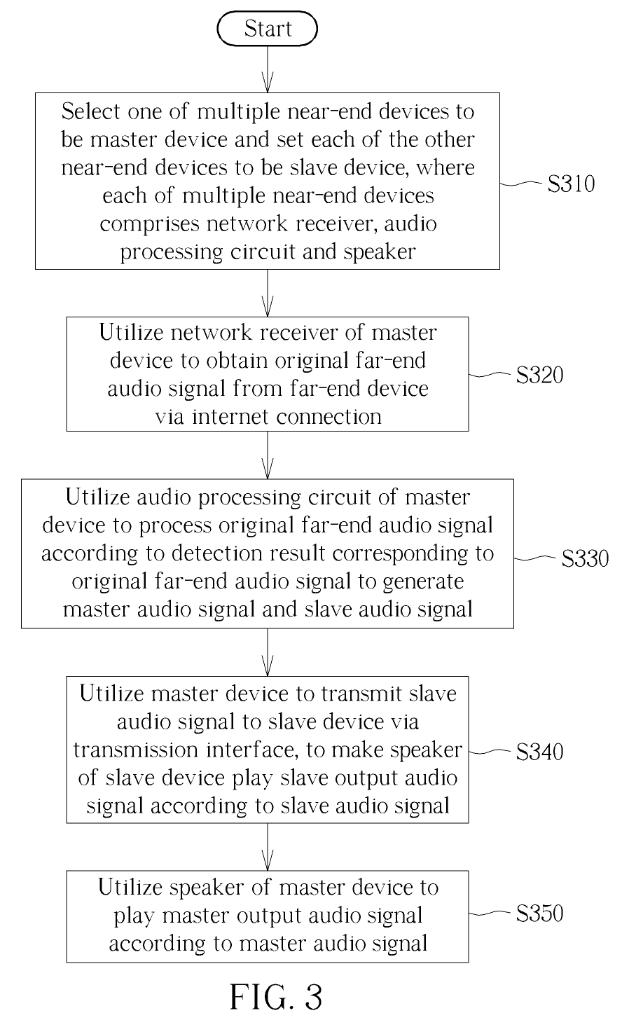

FIG. 3 is a diagram illustrating a working flow of a method for performing audio communication between a first space and a second space according to an embodiment of the present invention, where multiple near-end devices (e.g. the near-end devices 110, 120 and 130 shown in FIG. 1) are located in the first space, at least one far-end device (e.g. the far-end device 20 shown in FIG. 1) is located in the second space, and the working flow may be executed by a system formed by the near-end devices 110, 120 and 130 shown in FIG. 1. It should be noted that the working flow shown in FIG. 3 is only for illustrative purposes, and is not meant to be a limitation of the present invention. For example, one or more steps may be added, deleted or modified in the working flow shown in FIG. 3. In addition, if the same result can be obtained, these steps do not have to be executed in the exact order shown in FIG. 3.

In Step S310, the system may select one of the multiple near-end devices (e.g. the near-end device 120) to be a master device and set each of the other near-end devices (e.g. the near-end devices 110 and 130) to be a slave device, where each of the multiple near-end devices comprises a network receiver (e.g. the network receiver 210 shown in FIG. 2A), an audio processing circuit (e.g. the audio processing circuit 220 shown in FIG. 2A) and a speaker (e.g. the speaker 230 shown in FIG. 2A).

In Step S320, the system may utilize the network receiver of the master device to obtain an original far-end audio signal from the at least one far-end device via an internet connection.

In Step S330, the system may utilize the audio processing circuit of the master device to process the original far-end audio signal according to a detection result corresponding to the original far-end audio signal to generate a master audio signal and a slave audio signal.

In Step S340, the system may utilize the master device to transmit the slave audio signal to the slave device via a transmission interface, to make the speaker of the slave device play a slave output audio signal according to the slave audio signal.

In Step S350, the system may utilize the speaker of the master device to play a master output audio signal according to the master audio signal.

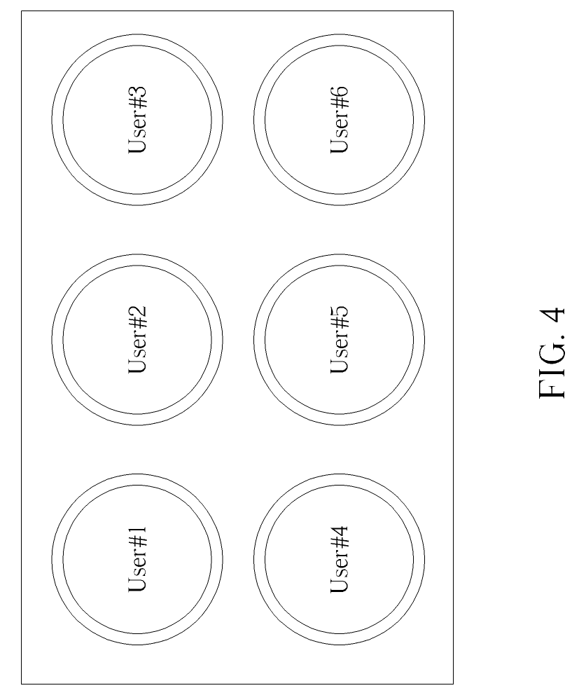

FIG. 4 is a diagram illustrating a display screen of multiple users (e.g. User #1, User #2, User #3, User #4, User #5 and User #6) having a conference call according to an embodiment of the present invention. As shown in FIG. 4, the display screen of the conference call may show images of User #1, User #2, User #3, User #4, User #5 and User #6 participating in this conference call. In order to allow each user to recognize which user a current voice corresponds to, the speaker of each of the near-end devices 110, 120 and 130 and the far-end device 20 may emit the current audio signal in a corresponding direction. For example, when a user in the second space (e.g. the user closest to the far-end device 20, assumed to be User #1) speaks, the detection result may comprise voice source information corresponding to the original far-end audio signal (e.g. sound source information output from the far-end device 20 along with the original far-end audio signal, which may indicate that the original far-end audio signal is the voice of User #1 in the second space), and the audio processing circuit 220 of the master device (e.g. the near-end device 120) may control the master audio signal and the slave audio signal according to the sound source information, to make the speaker of the master device (e.g. the speaker of the near-end device 120) play the master output audio signal in a corresponding direction of the sound source information (e.g. making a user in front of the near-end device 120 feel that the master output audio signal is emitted from an upper left of the display screen), and make the speaker of the slave device (e.g. the speaker of the near-end device 110 or 130) play the slave output audio signal in the corresponding direction (e.g. making a user in front of the near-end device 110 or 130 feel that the slave output audio signal is emitted from the upper left of the display screen). In addition, the display screen of the master device (e.g. the near-end device 120) and the slave device (e.g. the near-end device 110 or 130) may not be the same. For example, a position of User #1 on the display screen of the master device (e.g. the near-end device 120) and a position of User #1 on the display screen of the slave device (e.g. the near-end device 110 or 130) may be different, where the slave device (e.g. the near-end device 110 or 130) may perform corresponding processing on a playback direction of the master output audio signal according to the position of User #1 on the display screen of the slave device (e.g. the near-end device 110 or 130). That is, the user may feel that the current audio signal is emitted from the position of the corresponding user on the display screen, to facilitate judging from which user the current audio signal comes. By analogy, when User #3 speaks and makes the speakers of the other devices (e.g. the near-end devices 110, 120 and 130 and the far-end device 20) emit audio signals, the users located in front of the respective devices may feel that this audio signal is emitted from an upper right corner of the display screen. Thus, by controlling a direction in which the speaker emits the audio signal, the present invention can widen a sound field for a display position on software (e.g. a display position on conference call software of a user).

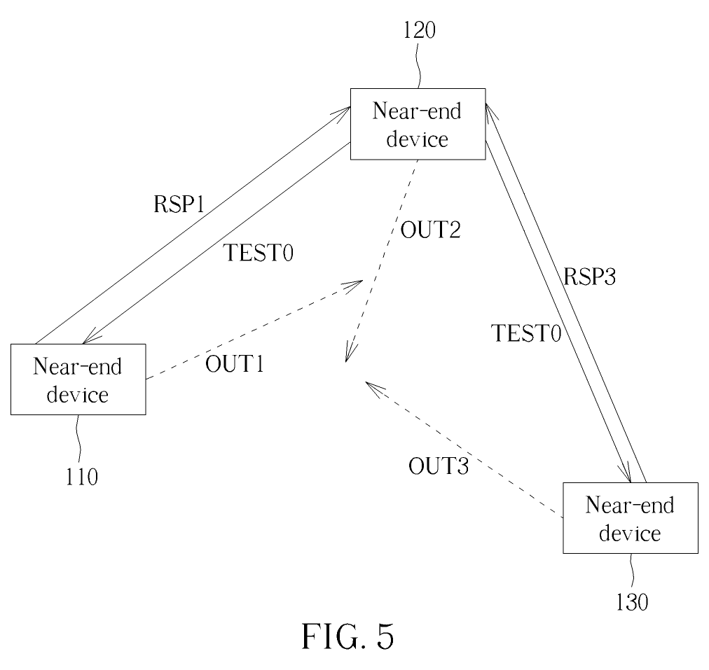

FIG. 5 is a diagram illustrating calibration of frequency responses of the sounds received by multiple near-end devices such as 110, 120 and 130 according to an embodiment of the present invention. When the near-end device 120 is selected to be the master device, each of the near-end devices 110 and 130 may be set to be the slave device. In this embodiment, the detection result may comprise a master-side frequency response result generated by the audio processing circuit of the master device (e.g. the audio processing circuit 220 of the near-end device 120) according to sound signals received by the microphone of the master device (e.g. the microphone 240 of the near-end device 120) and a slave-side frequency response result generated by the audio processing circuit of the slave device (e.g. the audio processing circuit 220 of the near-end device 110 and the audio processing circuit 220 of the near-end device 130) according to sound signals received by the microphone of the slave device (e.g. the microphone 240 of the near-end device 110 and the microphone 240 of the near-end device 130), and the audio processing circuit of the master device (e.g. the audio processing circuit 220 of the near-end device 120) may adjust the master audio signal and the slave audio signal according to the master-side frequency response result and the slave-side frequency response result, to flatten the master-side frequency response result and the slave-side frequency response result and make the master-side frequency response result and the slave-side frequency response result approach each other.

For example, the near-end device 120 serving as the master device may transmit a test signal TEST0 to the near-end devices 110 and 130, where the speaker 230 of the near-end device 110 may emit an audio signal OUT1 according to the test signal TEST0, the speaker 230 of the near-end device 120 may emit an audio signal OUT2 according to the test signal TEST0, and the speaker 230 of the near-end device 130 may emit an audio signal OUT3 according to the test signal TEST0. In a case where the near-end devices 110, 120 and 130 transmit audio signals simultaneously, the near-end device 110 may generate a frequency response result RSP1 according to the sound received by the microphone 240 of the near-end device 110, and the near-end device 130 may generate a frequency response result RSP3 according to the sound received by the microphone 240 of the near-end device 130, where the sound received by the microphone 240 of the near-end device 120 generates the master-side frequency response result, and the near-end device 120 may respectively obtain the slave-side frequency response results (e.g. the frequency response results RSP1 and RSP3) from the near-end devices 110 and 130 via the transmission interface IF1 (e.g. a Wi-Fi direct transmission interface or ultrasound reception/transmission). Thus, the near-end device 120 may obtain frequency response results at different positions in the first space (e.g. positions of the near-end devices 110, 120 and 130), and adjust or control parameters such as gain and delay of the audio signal of each device (e.g. the master audio signal and the slave audio signal transmitted to different slave devices) according to these frequency response results (e.g. the master-side frequency response result and the slave-side frequency response result), so as to make the frequency response results at different positions in the first space (e.g. positions of the near-end devices 110, 120 and 130) be flattened and tend to be consistent.

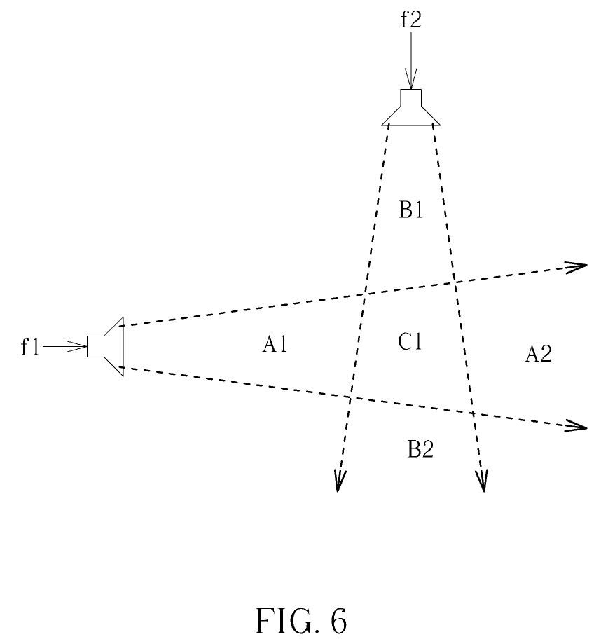

FIG. 6 is a diagram illustrating a directional speaker implemented by multiple near-end devices (e.g. a plurality of near-end devices among the near-end devices 110, 120 and 130) according to an embodiment of the present invention. Specifically, the audio processing circuit 220 of the near-end device 120 serving as the master device may frequency up-convert the master audio signal to a first ultrasound frequency band (e.g. modulated on an ultrasound frequency f1), to make the master output audio signal played by the speaker 230 of the near-end device 120 locate on the first ultrasound frequency band, and the audio processing circuit 220 of the near-end device 110 (and/or the near-end device 130) serving as the slave device may frequency up-convert the slave audio signal to a second ultrasound frequency band (e.g. modulated on an ultrasound frequency f2), to make the slave output audio signal played by the speaker 230 of the near-end device 110 locate on the second ultrasound frequency band. According to the transmission direction of the master output audio signal and the transmission direction of the slave output audio signal, the first space may comprise multiple regions such as A1, A2, B1, B2 and C1, as shown in FIG. 6. Only users located in regions A1, C1 and A2 may receive the master output audio signal modulated on the ultrasound frequency f1, and only users located in regions B1, C1 and B2 may receive the slave output audio signal modulated on the ultrasound frequency f2. However, since the ultrasound frequencies f1 and f2 do not locate on the audible frequency range (e.g. a human hearing range), users located in regions A1, A2, B1 and B2 cannot hear contents of the master output audio signal or the slave output audio signal. However, the master output audio signal modulated on the ultrasound frequency f1 and the slave output audio signal modulated on the ultrasound frequency f2 may intersect and perform parametric interaction in region C1, to make the master output audio signal and/or the slave output audio signal be demodulated to (f1 - f2), (f1 + f2), (2 × f1) and (2 × f2), where (f1 - f2) may fall in the audible frequency range. Thus, in the first space, the master output audio signal and the slave output audio signal are frequency down-converted to the audible frequency range only in an intersection region (e.g. region C1) of the master playback direction of the speaker 230 of the near-end device 120 and the slave playback direction of the speaker 230 of the near-end device 110. That is, only users located in region C1 can hear the contents of the master output audio signal or the slave output audio signal.

In summary, the embodiments of the present invention configure multiple near-end devices in a same space to transmit related information (which is required for optimizing overall playback quality in this space) to each other via Wi-Fi direct or ultrasound transmission/reception, and a near-end device serving as a master device processes this information to transmit a corresponding slave audio signal to other near-end devices, thereby preventing problems caused by factors such as network delay and spatial positions of the multiple near-end devices in this space on overall playback conditions. In addition, the embodiments of the present invention will not greatly increase additional costs. Thus, the present invention can improve the overall playback effect of multiple near-end devices playing the same audio signal in the same space without introducing any side effect or in a way that is less likely to introduce side effects.

The foregoing outlines the features of several embodiments, enabling those skilled in the art to fully appreciate the aspects of the present disclosure. Those skilled in the art should recognize that the present disclosure provides a foundation for designing or modifying other processes and structures to achieve substantially the same functions and/or substantially the same results as those of the embodiments introduced herein. Furthermore, such equivalent arrangements do not deviate from the spirit and scope of the present disclosure, and various changes, substitutions, and alterations may be made without so departing.

What is claimed is:

1. An electronic device for performing audio communication between a first space and a second space, wherein multiple near-end devices are located in the first space, at least one far-end device is located in the second space, the electronic device is one of the multiple near-end devices, and the electronic device comprises:
a network receiver, configured to obtain an original far-end audio signal from the at least one far-end device via an internet connection;
an audio processing circuit, configured to generate a processed audio signal according to a detection result corresponding to the original far-end audio signal;
a speaker, coupled to the audio processing circuit, configured to play an output audio signal according to the processed audio signal;
wherein when the electronic device is selected to be a master device, each of the other near-end devices is selected to be a slave device, the audio processing circuit of the master device processes the original far-end audio signal according to the detection result to generate a master audio signal and a slave audio signal, the master device transmits the slave audio signal to the slave device via a transmission interface, to make the speaker of the slave device play a slave output audio signal according to the slave audio signal, and the speaker of the master device plays a master output audio signal according to the master audio signal.

2. The electronic device of claim 1, wherein when the electronic device is a first near-end device connected to the audio communication between the first space and the second space among the multiple near-end devices, the electronic device is selected to be the master device.

3. The electronic device of claim 1, wherein each near-end device of the multiple near-end devices tests stability of connection to the internet of said each near-end device, and when the electronic device is a near-end device having a best network stability among the multiple near-end devices, the electronic device is selected to be the master device.

4. The electronic device of claim 1, wherein each near-end device of the multiple near-end devices selects a near-end device having a best position to be the master device according to the topology of the speaker array and the microphone array, and the other near-end devices are set to be the slave device.

5. The electronic device of claim 1, wherein the master device generates a master received signal according to a sound signal received by the master device from a sound source located in the first space, the slave device generates a slave received signal according to the sound signal received from the sound source, the master device obtains the slave received signal from the slave device via the transmission interface, and when the electronic device determines that a difference between a slave audio indicator of the slave received signal generated by a specific near-end device among the multiple near-end devices and a master audio indicator of the master received signal generated by the electronic device reaches a predetermined threshold, the electronic device is switched to be the slave device, and the specific near-end device is switched to be the master device.

6. The electronic device of claim 1, wherein the master device performs Wi-Fi peer-to-peer (P2P) transmission with the slave device via the transmission interface to transmit the slave audio signal to the slave device.

7. The electronic device of claim 1, wherein the master device modulates the slave audio signal on an ultrasound signal to make the speaker of the master device play the ultrasound signal, and a microphone of the slave device receives the ultrasound signal played by the speaker of the master device, to allow the slave device to obtain the slave audio signal modulated on the ultrasound signal.

8. The electronic device of claim 1, wherein the detection result comprises sound source information corresponding to the original far-end audio signal, and the audio processing circuit of the master device controls the master audio signal and the slave audio signal according to the voice source information, to make the speaker of the master device play the master output audio signal in a corresponding direction of the voice source information, and make the speaker of the slave device play the slave output audio signal in the corresponding direction.

9. The electronic device of claim 1, wherein the detection result comprises a master-side frequency response result generated by the audio processing circuit of the master device according to a sound signal received by a microphone of the master device and a slave-side frequency response result generated by the audio processing circuit of the slave device according to the sound signal received by a microphone of the slave device, and the audio processing circuit of the master device adjusts the master audio signal and the slave audio signal according to the master-side frequency response result and the slave-side frequency response result, to flatten the master-side frequency response result and the slave-side frequency response result and make the master-side frequency response result and the slave-side frequency response result approach each other.

10. The electronic device of claim 1, wherein the audio processing circuit of the master device frequency up-converts the master audio signal to a first ultrasound frequency band, to make the master output audio signal played by the speaker of the master device locate on the first ultrasound frequency band, the audio processing circuit of the slave device frequency up-converts the slave audio signal to a second ultrasound frequency band, to make the slave output audio signal played by the speaker of the slave device locate on the second ultrasound frequency band, and the master output audio signal and the slave output audio signal are frequency down-converted to an audible frequency range only in an intersection region of a master playback direction of the speaker of the master device and a slave playback direction of the speaker of the slave device.

11. A method for performing audio communication between a first space and a second space, wherein multiple near-end devices are located in the first space, at least one far-end device is located in the second space, and the method comprises:
selecting one of the multiple near-end devices to be a master device and setting each of the other near-end devices to be a slave device, wherein each of the multiple near-end devices comprises a network receiver, an audio processing circuit and a speaker;
utilizing the network receiver of the master device to obtain an original far-end audio signal from the at least one far-end device via an internet connection;
utilizing the audio processing circuit of the master device to process the original far-end audio signal according to a detection result corresponding to the original far-end audio signal to generate a master audio signal and a slave audio signal;
utilizing the master device to transmit the slave audio signal to the slave device via a transmission interface, to make the speaker of the slave device play a slave output audio signal according to the slave audio signal; and
utilizing the speaker of the master device to play a master output audio signal according to the master audio signal.

12. The method of claim 11, wherein the step of selecting one of the multiple near-end devices to be the master device comprises:
selecting a first near-end device connected to audio communication between the first space and the second space among the multiple near-end devices to be the master device.

13. The method of claim 11, wherein the step of selecting one of the multiple near-end devices to be the master device comprises:
utilizing each near-end device of the multiple near-end devices to test stability of connection to the internet of the each near-end device; and
selecting a near-end device having a best network stability among the multiple near-end devices to be the master device.

14. The method of claim 11, wherein the step of selecting one of the multiple near-end devices to be the master device comprises:
utilizing each near-end device of the multiple near-end devices to select a near-end device having a best position to be the master device according to the topology of the speaker array and the microphone array, and setting the other near-end devices to be the slave device.

15. The method of claim 11, further comprising:
utilizing the master device to generate a master received signal according to a sound signal received by the master device from a sound source located in the first space;
utilizing the slave device to generate a slave received signal according to the sound signal received from the sound source;
utilizing the master device to obtain the slave received signal from the slave device via the transmission interface; and
in response to an electronic device serving as the master device determining that a difference between a slave audio indicator of the slave received signal generated by a specific near-end device among the multiple near-end devices and a master audio indicator of the master received signal generated by the electronic device reaches a predetermined threshold, switching the electronic device to be the slave device, and switching the specific near-end device to be the master device.

16. The method of claim 11, further comprising:
utilizing the master device to perform Wi-Fi peer-to-peer (P2P) transmission with the slave device via the transmission interface to transmit the slave audio signal to the slave device.

17. The method of claim 11, further comprising:
utilizing the master device to carry the slave audio signal on an ultrasound signal to make the speaker of the master device play the ultrasound signal; and
utilizing a microphone of the slave device to receive the ultrasound signal played by the speaker of the master device, to allow the slave device to obtain the slave audio signal carried on the ultrasound signal.

18. The method of claim 11, wherein the detection result comprises sound source information corresponding to the original far-end audio signal, and the method further comprises:
utilizing the audio processing circuit of the master device to control the master audio signal and the slave audio signal according to the sound source information, to make the speaker of the master device play the master output audio signal in a corresponding direction of the sound source information, and make the speaker of the slave device play the slave output audio signal in the corresponding direction.

19. The method of claim 11, wherein the detection result comprises a master-side frequency response result generated by the audio processing circuit of the master device according to a sound signal received by a microphone of the master device and a slave-side frequency response result generated by the audio processing circuit of the slave device according to the sound signal received by a microphone of the slave device, and the method further comprises:
utilizing the audio processing circuit of the master device to adjust the master audio signal and the slave audio signal according to the master-side frequency response result and the slave-side frequency response result, to flatten the master-side frequency response result and the slave-side frequency response result and make the master-side frequency response result and the slave-side frequency response result approach each other.

20. The method of claim 11, further comprising:
utilizing the audio processing circuit of the master device to frequency up-convert the master audio signal to a first ultrasound frequency band, to make the master output audio signal played by the speaker of the master device locate on the first ultrasound frequency band; and
utilizing the audio processing circuit of the slave device to frequency up-convert the slave audio signal to a second ultrasound frequency band, to make the slave output audio signal played by the speaker of the slave device locate on the second ultrasound frequency band;
wherein the master output audio signal and the slave output audio signal are frequency down-converted to an audible frequency range only in an intersection region of a master playback direction of the speaker of the master device and a slave playback direction of the speaker of the slave device.
